(19) United States
(12) Patent Application Publication
(10) Pub. No.: US 2020/0087909 A1
(43) Pub. Date: Mar. 19, 2020

(54) FILTER FOR THE GRATE OF A STORM DRAIN

(71) Applicant: Jean-Paul Kamand, Burnaby (CA)

(72) Inventor: Jean-Paul Kamand, Burnaby (CA)

(21) Appl. No.: 16/134,848

(22) Filed: Sep. 18, 2018

(51) Int. Cl. E03F 5/04; C02F 1/00; B01D 35/143

(52) U.S. Cl. CPC E03F 5/0404; C02F 2103/001; B01D 35/143; C02F 1/001

(57) ABSTRACT

A filter for a grate of a storm drain, the grate having a plurality of grate slots, includes: (a) a plurality of parallel, spaced-apart chambers dimensioned for being inserted through the grate slots, each the chamber defining an open top and comprising a plurality of apertures in at least one side of the each chamber; and (b) a frame connecting the plurality of chambers to each other, the frame not obstructing the chambers from being inserted through the grate slots such that the filter is removably installable without moving the grate.

A lock inserts through one of the grate slots for locking the filter to at least one of the storm drain and the grate. The lock receives a key with a handle for removing the filter from the grate.

An indicator indicates when the filter is full. A solar panel powers the indicator.

### BACKGROUND OF THE INVENTION

### 1. Field of Invention

This invention relates to storm water drains having storm-drain grates and, in particular, to a storm-drain filter that can be removably installed without needing to remove and replace the grate of the storm drain.

### 2. Description of Related Art

Storm drains receive storm water into a catch basin through grate slots in a grate. The collected storm water is typically not treated and exits the storm water system into natural bodies of water such as lakes, rivers, sea or ocean. The storm water typically includes excess rain and ground water, and also includes debris that can be a source of water pollution. In particular, cigarette butts are small enough to enter into a storm drain via unfiltered grate slots in a grate of the storm drain and end up polluting natural bodies of water.

An object of the invention is to address the above shortcomings.

### SUMMARY

The above shortcomings may be addressed by providing, in accordance with one aspect of the invention, a filter for a grate of a storm drain, the grate having a plurality of grate slots. The filter includes: (a) a plurality of parallel, spaced-apart chambers dimensioned for being inserted through the grate slots, each the chamber defining an open top and comprising a plurality of apertures in at least one side of the each chamber; and (b) a frame connecting the plurality of chambers to each other, the frame not obstructing the chambers from being inserted through the grate slots such that the filter is removably installable without moving the grate.

Each of the chambers may have a width and a height, the height being greater than the width. Each of the chambers may be rectangular. Each of the chambers may be curved. The plurality of apertures may include upper apertures proximal to the open top and lower apertures distal from the open top. The upper apertures may be larger than the lower apertures. The filter may further include a lock dimensioned to insert through one of the grate slots for locking the filter to at least one of the storm drain and the grate. The lock may be operable to receive a key having an elongated handle for assisting removal of the filter from the grate. The lock may be dimensioned to permit the key to pass entirely through the lock. The filter may further include an indicator for indicating when the filter is full. The frame may include a plurality of connecting segments for connecting the plurality of chambers. The plurality of connecting segments may be dimensioned for resting atop the grate when the filter is installed into the grate. The filter may further include an indicator for indicating when the filter is full. The indicator may be attached to at least one of the connecting segments. The filter may further include a solar panel for electrically powering the indicator. The indicator may include a light-emitting diode.

In accordance with another aspect of the invention, there is provided a a filter for a grate of a storm drain, the grate having a plurality of grate slots. The filter includes: (a) filtering means for filtering runoff entering the storm drain, the filtering means defining an open top and being dimensioned for being inserted through the grate slots, the filtering means comprising a plurality of apertures in at least one side of the filtering means; and (b) frame means for supporting the filtering means, the frame means not obstructing the filtering means from being inserted through the grate slots such that the filtering means is removably installable without moving the grate.

The filter may further include locking means for locking the filtering means to at least one of the storm drain and the grate. The filter may further include indication means for indicating when the filtering means is full. The filter may further include powering means for electrically powering the indicator.

The foregoing summary is illustrative only and is not intended to be in any way limiting. Other aspects and features of the present invention will become apparent to those of ordinary skill in the art upon review of the following description of embodiments of the invention in conjunction with the accompanying figures and claims.

### BRIEF DESCRIPTION OF THE DRAWINGS

In drawings which illustrate by way of example only embodiments of the invention:

FIG. 1 is a perspective view of a storm-drain filter according to a first embodiment of the invention, showing the filter installed into a storm-drain grate;

FIG. 2 is an assembly diagram of the filter shown in FIG. 1, showing a lock of the filter;

FIG. 3 is a perspective view of the lock shown in FIG. 2, showing a key;

FIG. 4 is an upper perspective view of a storm-drain filter according to a second embodiment of the invention, showing a plurality of curved filtering chambers and a light-emitting diode;

FIG. 5 is a lower perspective view of the storm-drain filter shown in FIG. 4, showing bottom sides of the filtering chambers;

FIG. 6 is an upper perspective view of the storm-drain filter shown in FIGS. 4 and 5, showing the filter installed into a grate and showing a solar panel; and

FIG. 7 is a perspective view of a variation of the storm-drain filter shown in FIGS. 4 to 6, showing one chamber having sets of rows of differently sized apertures on opposing sides of the chamber.

### DETAILED DESCRIPTION

A filter for a grate of a storm drain, the grate having a plurality of grate slots, includes: (a) filtering means for filtering runoff entering the storm drain, said filtering means defining an open top and being dimensioned for being inserted through the grate slots, said filtering means comprising a plurality of apertures in at least one side of said filtering means; and (b) frame means for supporting said filtering means, said frame means not obstructing said filtering means from being inserted through the grate slots such that the filtering means is removably installable without moving the grate.

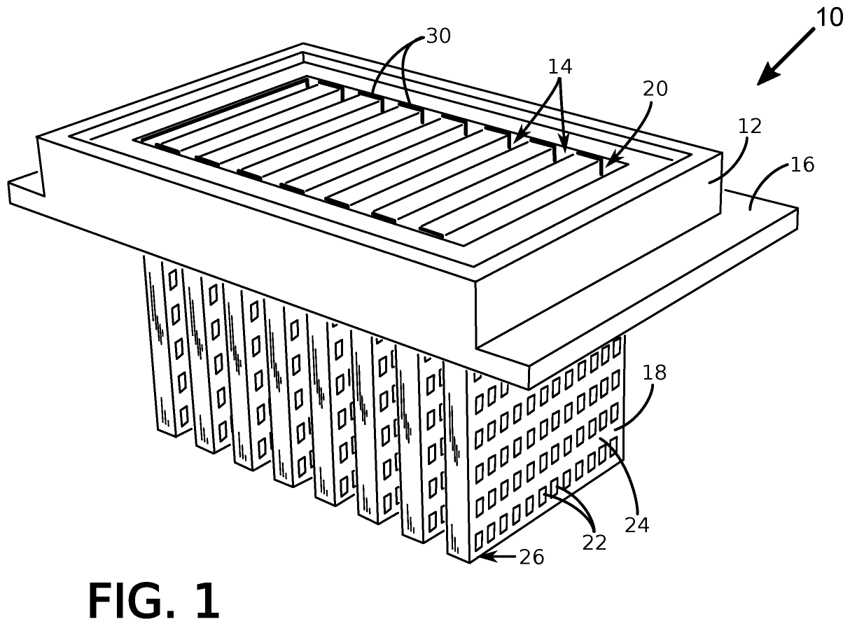

Referring to FIG. 1, the filter according to a first embodiment of the invention is shown generally at 10. The filter 10 can be installed at the grate 12 through its grate slots 14 at the inlet of a storm drain 16 (only a portion of which is shown in FIG. 1) to gather debris that would otherwise enter into the storm drain 16 with the potential of polluting natural bodies of water.

The filter 10 includes a number of chambers, such as the rectangular chambers 18 shown in FIG. 1. Each chamber 18 is open at its top 20, and has apertures 22 on one side 24 of each chamber 18. Typically, the apertures 22 near the top 20 of the chambers 18 are larger in size than the apertures 22 closer to the bottom 26 of the chambers 18, thereby advantageously collecting debris (not shown) when the filter 10 is empty or otherwise less than full of debris, while avoiding flooding of storm water above the filter 10 when the filter 10 becomes full.

In variations, the apertures 22 may be disposed on any or all of the four sides of the rectangular chamber 18. While the bottoms 26 of each chamber 18 typically do not include any of the apertures 22 so as to provide a solid floor for capturing debris captured by the filter 10, in some embodiments there are apertures 22 disposed at the bottom 26.

Each chamber 18 has a width that is sufficiently narrow to permit the chamber 18 to be inserted into the grate slots 14, and a length approximately equal to but less than the length of its corresponding grate slot 14. The height of each chamber 18 is preferably greater than its width. In variations, the height may be greater than that shown in the Figures. Generally the greater the height, the greater the holding capacity of the filter 10 becomes, which can advantageously decrease the likelihood of flooding in the vicinity of the filter 10. The maximum height of the chambers 18 is typically determined by the dimensions of the catch basin (not shown) within the storm drain 16 beneath the grate 12.

The rectangular chambers 18 are connected to each other by a frame, such as the wire frame 28 defining connecting segments 30 that rest atop the grate 12 when the filter 10 is installed at the grate 12. The wire frame 28 is dimensioned to not impede the rectangular chambers 18 from being inserted through the grate slots 14 from above the grate 12. Accordingly, the filter 10 advantageously can be installed and removed without needing to move the grate 12, including not needing to move the grate 12 away from its place at the inlet of the storm drain 16.

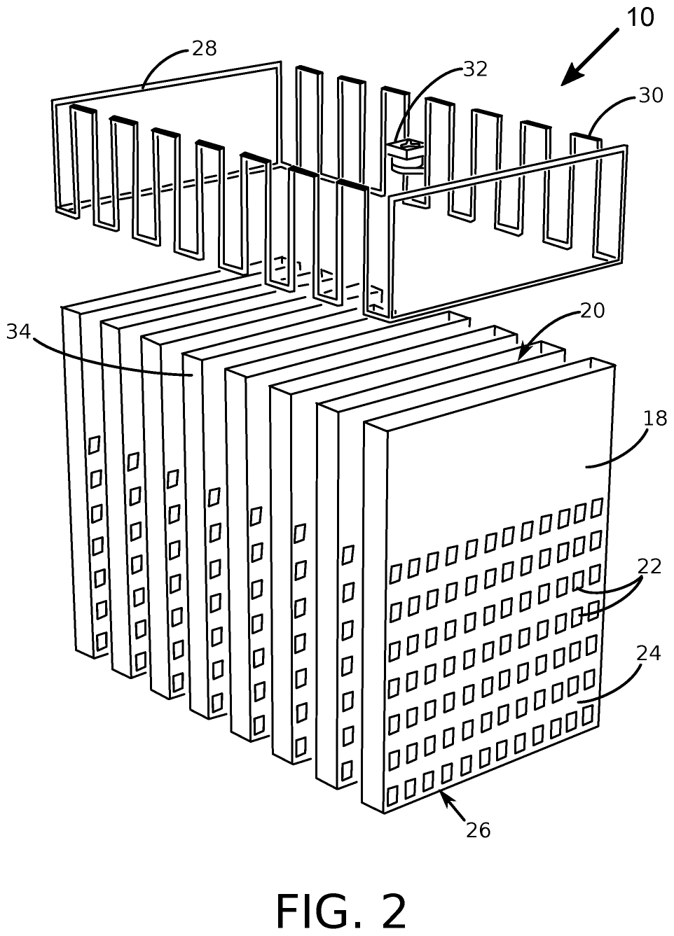

Referring to FIG. 2, the filter 10 in the first embodiment optionally includes a lock 32 for locking the filter 10 in place after the filter has been installed. To accommodate the lock 32, the filter 10 includes a shortened chamber 34 that is not as long as the other chambers 18. Typically, the shortened chamber 34 has the same width and height as the other chambers 18.

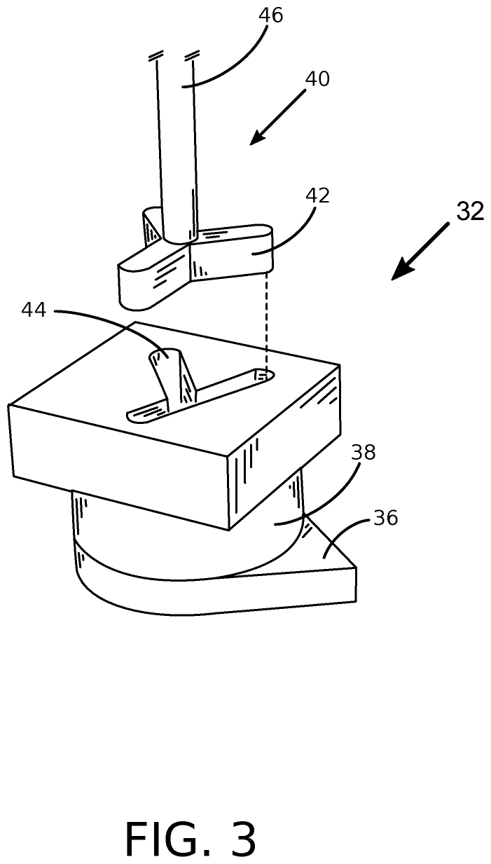

Referring to FIG. 3, the lock 32 includes a latch 36 that is rotatable relative to the main body 38 of the lock 32 by inserting a key 40 having a shape-matched keyed portion 42 through the keyhole 44 of the lock 32 and rotating the key 40. In general, the keyhole 44 and the key 40 may have any suitable matching shapes, including being generally rectangular with the key 40 having key teeth (not shown) for operating the lock 32. The keyhole 44 and the key 40 in some embodiments have non-standard matching shapes as an additional security measure.

The lock 32 in some embodiments is dimensioned to lock the filter 10 to the grate 12, such as by the latch 36 being rotatable until projecting underneath the bottom of the grate 12. Additionally or alternatively, the filter 10 in some embodiments is operable to be locked to the storm drain 16 (FIG. 1).

The key handle 46 preferably has a sufficient length for ordinary use. In some embodiments, the key handle 46 is sufficiently long to act as a lifting bar to assist in installing and removing the filter 10 from the grate 12.

In some embodiments, the lock 32 is dimensioned to permit the key 40 to pass entirely through the lock 32, such as by the keyhole 44 extending entirely through the lock 32. In such embodiments, the key 40 can be inserted a specifiable distance into the keyhole 44, rotated if necessary to place the latch 36 in an unlocked position, and then continued further until the keyed portion 42 passes the lock 32. Upon passing the lock 32, the key handle 46 shaft can be wedged within the keyhole 44 to assist in installing and/or removing the filter 10.

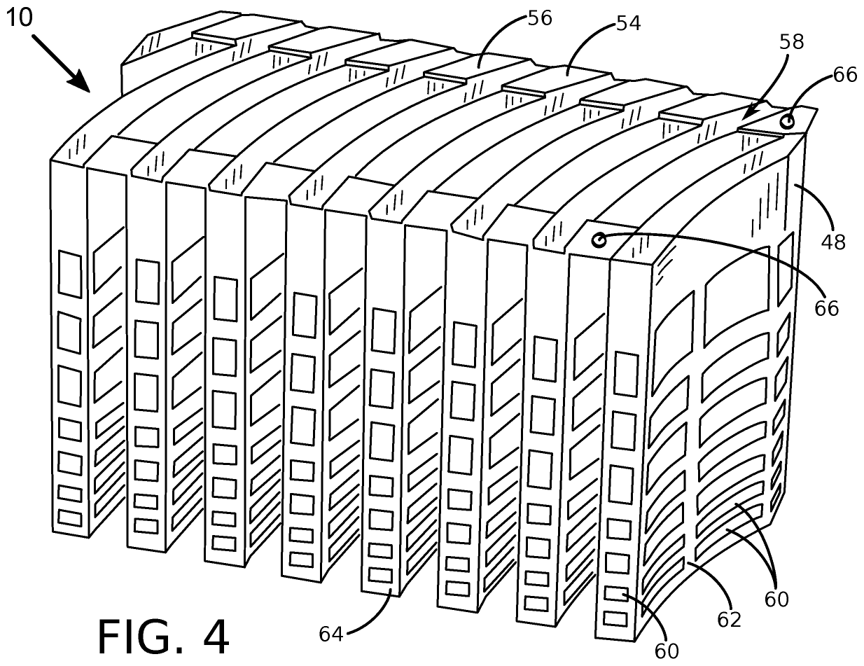

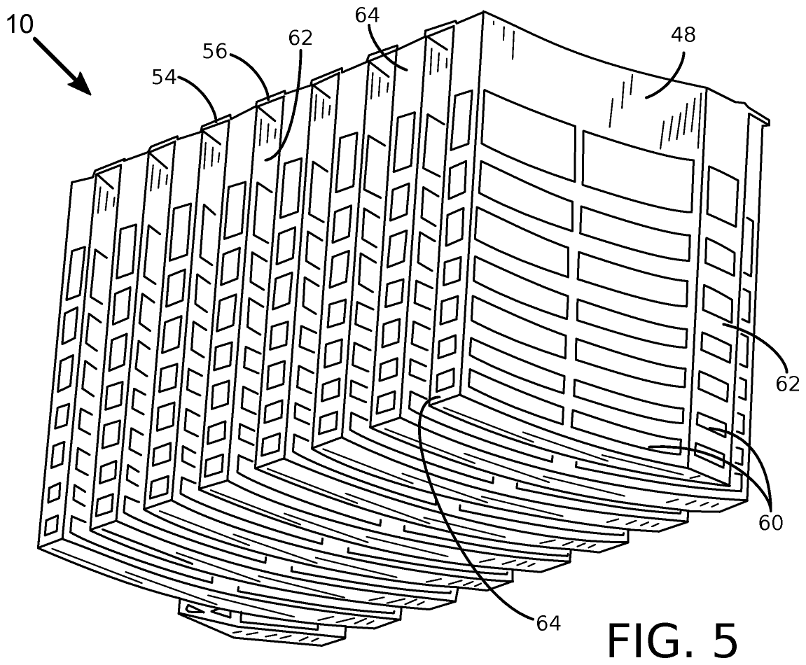

Referring to FIGS. 4 to 6, the filter 10 according to a second embodiment of the invention includes a number of curved chambers 48 that are shape-matched to the alternative grate slots 50 of the alternative grate 52. In general, any variety of filters 10 having differently shaped chambers may be employed for differently shaped grates.

The filter 10 of the second embodiment includes a frame, such as the integral frame 54 having integral connectors 56 connecting the curved chambers 48. In a variation, the wire frame 28 (FIGS. 1 and 2) may be suitably employed in the filter 10 of the second embodiment (FIGS. 4 to 6). In further variations, the lock 32 (FIGS. 1 to 3) may be suitably employed in the filter 10 of the second embodiment (FIGS. 4 to 6).

The chambers and the frame of any embodiment may be made of any suitable material or materials. For example, the integral frame 54 and the curved chambers 48 of the second embodiment are made of a plastic or similar material, and may be fabricated as a single piece by injection molding or similar. Preferably, the filter 10 is made of recyclable material(s) if possible.

Each curved chamber 48 is open at its top 58, and has apertures 60 on two sides 62 and 64 of each curved chamber 48.

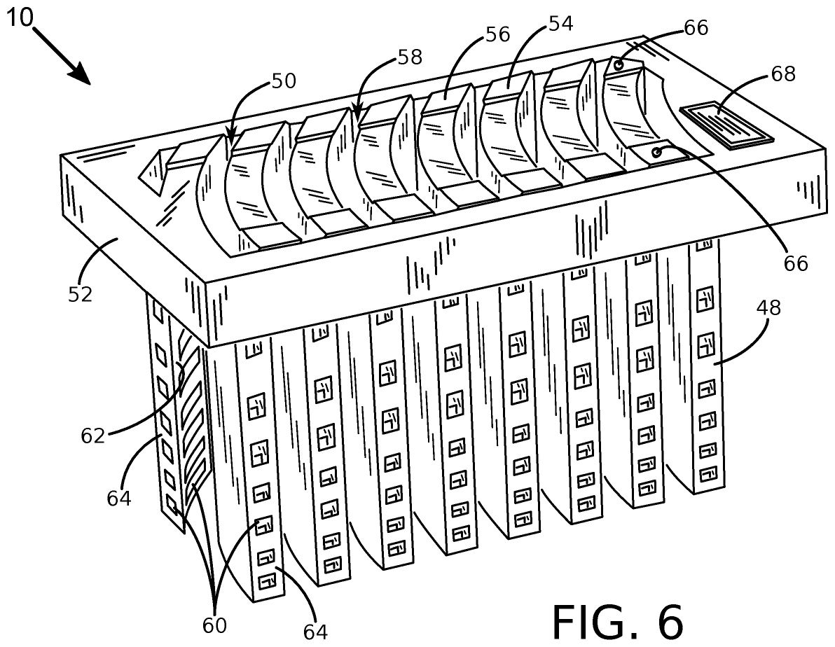

Referring to FIG. 6, the filter 10 in some embodiments includes an indicator, such as one or more Light-Emitting Diodes (LEDs) 66 or similar, for indicating when the filter 10 is full and should be cleaned and/or replaced.

The LED 66 is typically powered by an electronic circuit (not shown) that is also operable to determine a level of debris being held in the filter 10 and to determine when the filter 10 is full.

In the embodiment of FIG. 6, the electronic circuit is solar-powered via solar panel(s) such as the top-mounted solar panel 68.

The solar panel 68 is attached to the integral frame 54 as shown in FIG. 6. Additionally or alternatively, the solar panel 68 in some embodiments is attached to the grate 12, the storm drain 16, both or neither. In general, the solar panel 68 may be installed at any suitable location, including on a post (not shown) nearby the grate 12. Additionally or alternatively to employing the solar panel 68, the LED 66 may be wired to a source of electrical power such as a municipal or telecommunications supply, battery-powered, powered by other renewable energy sources, other electrical powering means, and any combination thereof for example. In general, the indicator may be electrically powered, entirely mechanical (not shown), or a combination thereof for example.

In a variation, the filter 10 of the first embodiment (FIGS. 1 to 3) includes the LED 66 and may also include the solar panel 68, with any necessary changes being made.

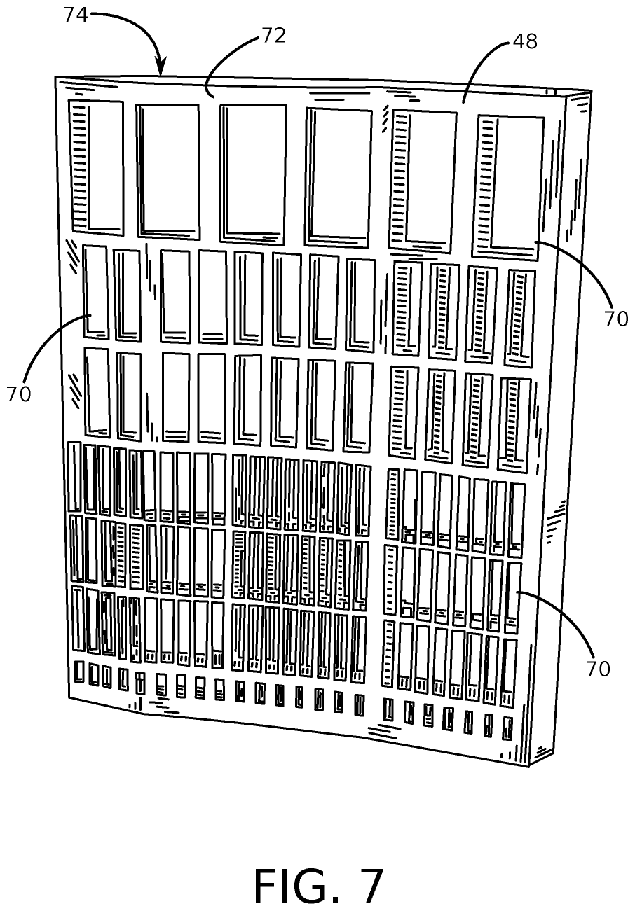

Referring to FIG. 7, a variation of the curved chamber 48 has apertures 70 on opposing sides 72 and 74 of the curved chamber 48. In general, any number of apertures of any suitable shape(s) and arrangement(s) may be employed in accordance with any embodiment of the present invention.

Thus, there is provided a filter for a grate of a storm drain, the grate having a plurality of grate slots, the filter comprising: (a) a plurality of parallel, spaced-apart chambers dimensioned for being inserted through the grate slots, each said chamber defining an open top and comprising a plurality of apertures in at least one side of said each chamber; and (b) a frame connecting said plurality of chambers to each other, said frame not obstructing said chambers from being inserted through the grate slots such that the filter is removably installable without moving the grate.

While embodiments of the invention have been described and illustrated, such embodiments should be considered illustrative of the invention only. The invention may include variants not described or illustrated herein in detail. Thus, the embodiments described and illustrated herein should not be considered to limit the invention as construed in accordance with the accompanying claims.

What is claimed is:

1. A filter for a grate of a storm drain, the grate having a plurality of grate slots, the filter comprising:
(a) a plurality of parallel, spaced-apart chambers dimensioned for being inserted through the grate slots, each said chamber defining an open top and comprising a plurality of apertures in at least one side of said each chamber; and
(b) a frame connecting said plurality of chambers to each other, said frame not obstructing said chambers from being inserted through the grate slots such that the filter is removably installable without moving the grate.

2. The filter of claim 1 wherein each said chamber has a width and a height, the height being greater than the width.

3. The filter of claim 1 wherein each said chamber is rectangular.

4. The filter of claim 1 wherein each said chamber is curved.

5. The filter of claim 1 wherein said plurality of apertures comprises upper apertures proximal to the open top and lower apertures distal from the open top, the upper apertures being larger than the lower apertures.

6. The filter of claim 2 wherein said plurality of apertures comprises upper apertures proximal to the open top and lower apertures distal from the open top, the upper apertures being larger than the lower apertures.

7. The filter of claim 1 further comprising a lock dimensioned to insert through one of the grate slots for locking the filter to at least one of the storm drain and the grate.

8. The filter of claim 6 further comprising a lock dimensioned to insert through one of the grate slots for locking the filter to at least one of the storm drain and the grate.

9. The filter of claim 7 wherein said lock is operable to receive a key having an elongated handle for assisting removal of the filter from the grate.

10. The filter of claim 9 wherein said lock is dimensioned to permit the key to pass entirely through said lock.

11. The filter of claim 1 further comprising an indicator for indicating when the filter is full.

12. The filter of claim 1 wherein said frame comprises a plurality of connecting segments for connecting said plurality of chambers, said plurality of connecting segments being dimensioned for resting atop the grate when the filter is installed into the grate.

13. The filter of claim 7 wherein said frame comprises a plurality of connecting segments for connecting said plurality of chambers, said plurality of connecting segments being dimensioned for resting atop the grate when the filter is installed into the grate.

14. The filter of claim 13 further comprising an indicator for indicating when the filter is full, said indicator being attached to at least one said connecting segment.

15. The filter of claim 11 further comprising a solar panel for electrically powering said indicator.

16. The filter of claim 15 wherein said indicator comprises a light-emitting diode.

17. A filter for a grate of a storm drain, the grate having a plurality of grate slots, the filter comprising:
(a) filtering means for filtering runoff entering the storm drain, said filtering means defining an open top and being dimensioned for being inserted through the grate slots, said filtering means comprising a plurality of apertures in at least one side of said filtering means; and
(b) frame means for supporting said filtering means, said frame means not obstructing said filtering means from being inserted through the grate slots such that the filtering means is removably installable without moving the grate.

18. The filter of claim 17 further comprising locking means for locking the filtering means to at least one of the storm drain and the grate.

19. The filter of claim 17 further comprising indication means for indicating when the filtering means is full.

20. The filter of claim 19 further comprising powering means for electrically powering said indicator.
